(19) United States
(12) Patent Application Publication
(10) Pub. No.: US 2011/0148946 A1
(43) Pub. Date: Jun. 23, 2011

(54) IMAGE DISPLAY APPARATUS

(75) Inventor: Taro Hiroike, Yamato-shi (JP)

(73) Assignee: CANON KABUSHIKI KAISHA, Tokyo (JP)

(21) Appl. No.: 12/972,343

(22) Filed: Dec. 17, 2010

(30) Foreign Application Priority Data
Dec. 21, 2009 (JP) 2009-289729

(51) Int. Cl. G09G 5/10

(52) U.S. Cl. 345/690

(57) ABSTRACT

The image display apparatus includes first lines connecting electron-emitting devices which each include a pair of electrodes and an electron-emitting portion located between the electrodes, second lines having a resistance greater than that of the first lines, an insulating layer covering the second lines, and a resistive film which is connected to the first lines, which covers the insulating layer, and which has a surface resistivity of 10⁸ Ω/square or more. The resistive film has portions which do not overlap with the second lines and which are connected to the first lines. The distance L between each of the portions of the resistive film that are connected to the first lines and a corresponding one of the portions of the resistive film that overlap with the second lines is five times or more the thickness T of the insulating layer.

### BACKGROUND OF THE INVENTION

1. Field of the Invention

The present invention relates to an image display apparatus including a resistive film.

2. Description of the Related Art

The following apparatuses are being studied: image display apparatuses each including a rear plate including a plurality of electron-emitting devices wired to each other and a face plate which includes an anode for accelerating electrons emitted from the electron-emitting devices and light-emitting members that emit light when being irradiated with the accelerated electrons and which is placed opposite the rear plate at a distance of several millimeters. In this type of image display apparatus, there is a concern that discharge breakdown occurs between an anode and electron-emitting devices. In order to cope with the discharge breakdown therebetween, Japanese Patent Laid-Open No. 2006-127794 discloses a configuration in which conductive members, excluding electron-emitting portions, arranged on an electron source substrate are covered with an insulating member and also discloses a configuration in which the insulating member covers the conductive members and is covered with a resistive member.

In the configuration disclosed in Japanese Patent Laid-Open No. 2006-127794, the resistive member and the conductive members are arranged with the insulating member disposed therebetween; hence, reactive power consumption is caused because of charge and discharge currents due to the capacitance between the resistive member and the conductive members.

### SUMMARY OF THE INVENTION

The present invention provides an image display apparatus including a rear plate including a plurality of electron-emitting devices which each include a pair of electrodes and an electron-emitting portion located between the electrodes, first lines connecting the electrodes each located on one side of a corresponding one of the electron-emitting devices, second lines which connect the electrodes each located on the other side of a corresponding one of the electron-emitting devices and which have a resistance greater than that of the first lines, an insulating layer covering the second lines, and a resistive film which is connected to the first lines, which has portions overlapping with the second lines, which covers the insulating layer, and which has a surface resistivity of 10⁸ Ω/square or more. The image display apparatus also includes a face plate including an anode held at a potential higher than that of the electron-emitting devices and light-emitting members that emit light when being irradiated with the electrons emitted from the electron-emitting devices. The resistive film has portions which do not overlap with the second lines and which are connected to the first lines and the inequality L≧5T is satisfied, where L is the distance between each of the portions of the resistive film that are connected to the first lines and a corresponding one of the portions of the resistive film that overlap with the second lines and T is the thickness of the insulating layer.

Further features of the present invention will become apparent from the following description of exemplary embodiments with reference to the attached drawings.

### BRIEF DESCRIPTION OF THE DRAWINGS

FIG. 1 is a partial cutaway perspective view of an image display apparatus according to an embodiment of the present invention.

FIG. 2A is a partially enlarged view of one of electron-emitting devices included in the image display apparatus shown in FIG. 1.

FIG. 2B is an illustration of a rear plate including a resistive film disposed on an insulating layer covering column lines.

FIGS. 3A to 3C are schematic graphs illustrating the changes in potential with time of portions of a resistive film and FIG. 3D is a graph illustrating the change in potential with time of a conductor.

FIG. 4A is an illustration showing the potential distribution of the resistive film shown in FIG. 2B.

FIG. 4B is a graph showing the relationship between the lengths of Regions A of resistive films and the thicknesses of insulating layers.

FIGS. 5A to 5E are illustrations showing steps of preparing a rear plate used in an example of the present invention.

FIGS. 6F to 6H are illustrations showing steps of preparing the rear plate used in the example.

FIG. 7 is an illustration of an electron-emitting device prepared in a comparative example.

### DESCRIPTION OF THE EMBODIMENTS

Embodiments of the present invention will now be described with reference to the attached drawings.

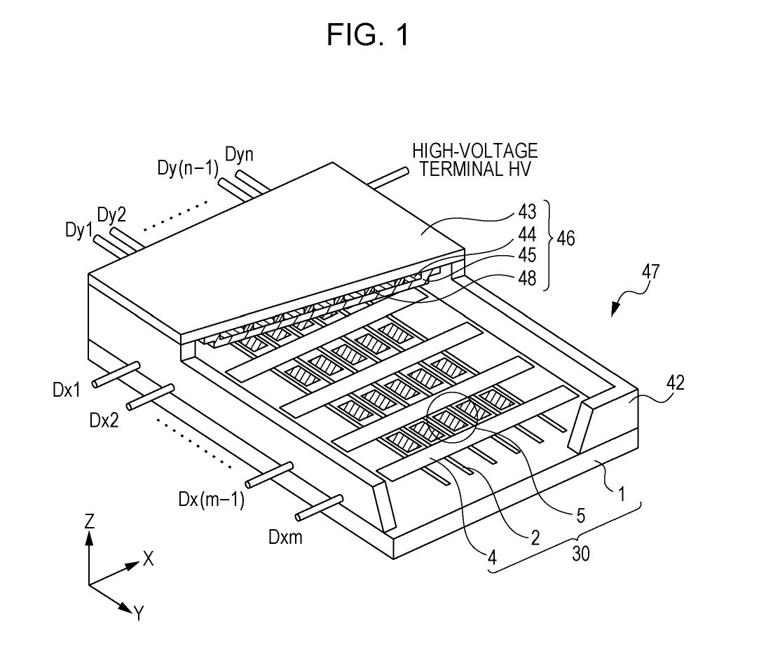

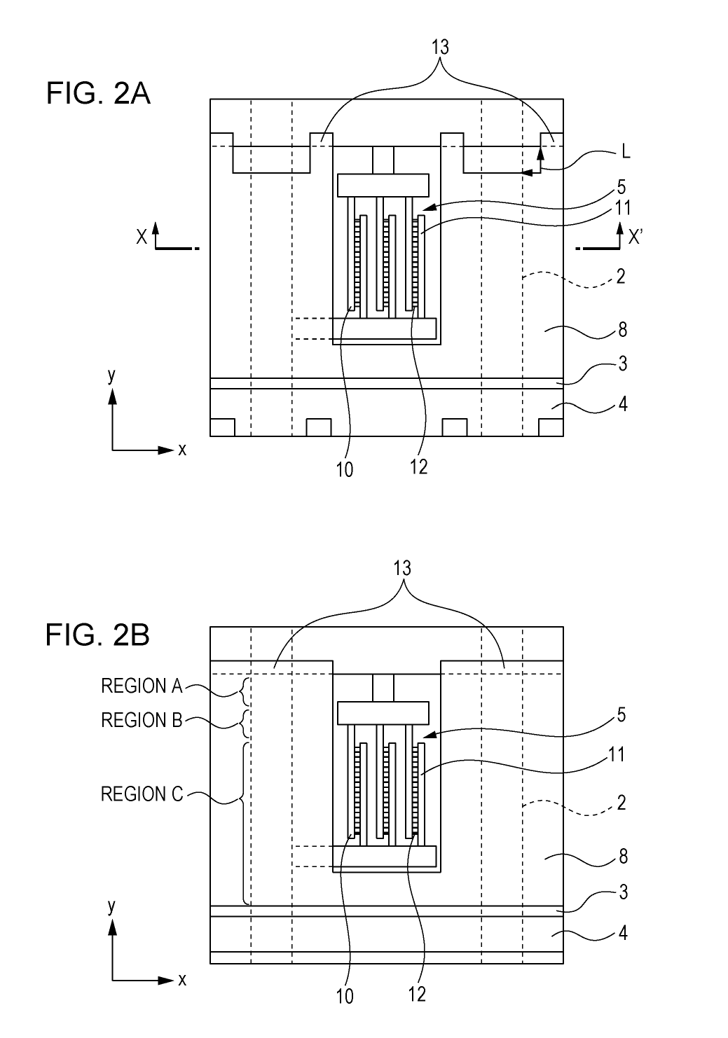

FIG. 1 is a partial cutaway perspective view of an image display apparatus 47 according to an embodiment of the present invention. FIG. 2A is a partially enlarged view of one of electron-emitting devices 5 included in the image display apparatus 47 shown in FIG. 1.

With reference to FIG. 1, the image display apparatus 47 includes a frame 42, a face plate 46, and a rear plate 30 bonded to the face plate 46 with the frame 42 disposed therebetween. The face plate 46 includes a front substrate 43, a plurality of light-emitting members 44 arranged on the front substrate 43, and an anode 45 which is held at a potential higher than that of the electron-emitting devices 5 such that electrons emitted from the electron-emitting devices 5 are accelerated. The light-emitting members 44 emit light when being irradiated with the electrons emitted from the electron-emitting devices 5. The rear plate 30 includes a back substrate 1, the electron-emitting devices 5, a plurality of row lines 4 that are first lines, and a plurality of column lines 2 that are second lines. The electron-emitting devices 5 are arranged on the back substrate 1 in a matrix pattern. With reference to FIG. 2A, the electron-emitting devices 5 each include a cathode 10 and gate 11 that are a pair of electrodes and an electron-emitting portion 12 located therebetween. In the electron-emitting devices 5, the cathodes 10 are connected to each other through the row lines 4 and the gates 11 are connected to each other through the column lines 2. The column lines 2 have a resistance greater than that of the row lines 4 and are covered with an insulating layer 3.

In a usual image display apparatus, there is a difference between the height and width of the screen and the number of pixels arranged in a column is different from the number of pixels arranged in a row. Hence, lines connecting a plurality of electron-emitting devices arranged to correspond to the pixels are different in length and/or width and therefore are different in resistance. In this embodiment, the column lines 2 have a resistance greater than that of the row lines 4. However, the row lines 4 may have a resistance greater than that of the column lines 2. What is important is that lines having higher resistance are covered with the insulating layer 3.

Since the column lines 2 are covered with the insulating layer 3, discharge breakdown can be prevented from occurring between the anode 45 and the column lines 2 (the column lines 2 can be prevented from being directly struck by discharge) even if discharge breakdown occurs accidentally between the face plate 46 and the rear plate 30. Since discharge breakdown can be prevented from occurring between the anode 45 and the column lines 2, which have higher resistance, all the electron-emitting devices 5 connected to the column lines 2 can be prevented from being deteriorated, that is, line defects can be prevented from occurring. This is described below in detail.

The occurrence of discharge breakdown between the anode 45 and the row lines 4 or the column lines 2 causes the potential of a line struck by discharge to increase to a voltage determined by the product of the discharge current flowing through the line and the resistance of the line. If discharge currents flow through the column lines 2, the potential thereof increases more significantly because the column lines 2 have a resistance greater than that of the row lines 4. Hence, if discharge currents flow through the column lines 2, all the electron-emitting devices 5 connected to the column lines 2 are held at potential and therefore electron-emitting properties of the electron-emitting devices 5 are seriously deteriorated, that is, so-called “line defects” are caused. However, in this embodiment, the column lines 2, which have higher resistance, can be prevented from being struck by discharge breakdown and therefore such line defects can be prevented.

In this embodiment, the image display apparatus 47 includes a resistive film 8 which is connected to the row lines 4, which has portions overlapping with the column lines 2, and which covers the insulating layer 3. The resistive film 8 has portions which do not overlap with the column lines 2 and which are connected to the row lines 4. The inequality L≧5T (hereinafter referred to as Inequality 1 in some cases) is satisfied, wherein L is the distance between each of portions 13 of the resistive film 8 that are connected to the row lines 4 and a corresponding one of the portions of the resistive film 8 that overlap with the column lines 2 and T is the thickness of the insulating layer 3. In this embodiment, in order to satisfy the inequality, the portions 13 of the resistive film 8 that are connected to the row lines 4 are displaced from the column lines 2 so as not to overlap with the column lines 2 as shown in FIG. 2A and portions of the resistive film 8 that are spaced from the portions 13 of the resistive film 8 that are connected to the row lines 4 at a distance of less than 5T do not overlap with the column lines 2. The thickness T of the insulating layer 3 is the thickness of portions of the insulating layer 3 that correspond to the portions of the resistive film 8 that overlap with the column lines 2, that is, the thickness of portions of the insulating layer 3 that are sandwiched between the resistive film 8 and the column lines 2. This allows the trajectories of electrons emitted from the electron-emitting devices 5 to be stabilized; hence, power consumption can be reduced. This is described below in detail.

Since the column lines 2 are covered with the insulating layer 3, the occurrence of line defects can be prevented as described above. However, there is a problem in that the surface of the insulating layer 3 is electrically charged and therefore the trajectories of electron beams emitted from the electron-emitting devices 5 are unstable. In order to cope with the problem, the resistive film 8 is placed over the insulating layer 3 and is connected to the row lines 4. This allows the resistive film 8 to function as an antistatic film to prevent the surface of the insulating layer 3 from being electrically charged; hence, the trajectories of the electron beams are stable. Even if discharge breakdown occurs between the anode 45 and the resistive film 8, discharge currents can be prevented from flowing into the column lines 2, which are higher in resistance than the row lines 4, because the resistive film 8 is connected to the row lines 4.

The resistive film 8, which is connected to the row lines 4, extends over the insulating layer 3 so as to partly overlap with the column lines 2; hence, a charge current flows depending on capacitors formed between the resistive film 8 and the column lines 2 and therefore electric power is consumed. However, it takes time before a charge current flows through the resistive film 8 because the resistive film 8 overlaps with the column lines 2 with the insulating layer 3 disposed therebetween and is made of a resistive material. Therefore, electric power is not necessarily consumed in proportion to the area where the resistive film 8 overlaps with the column lines 2. This is described below.

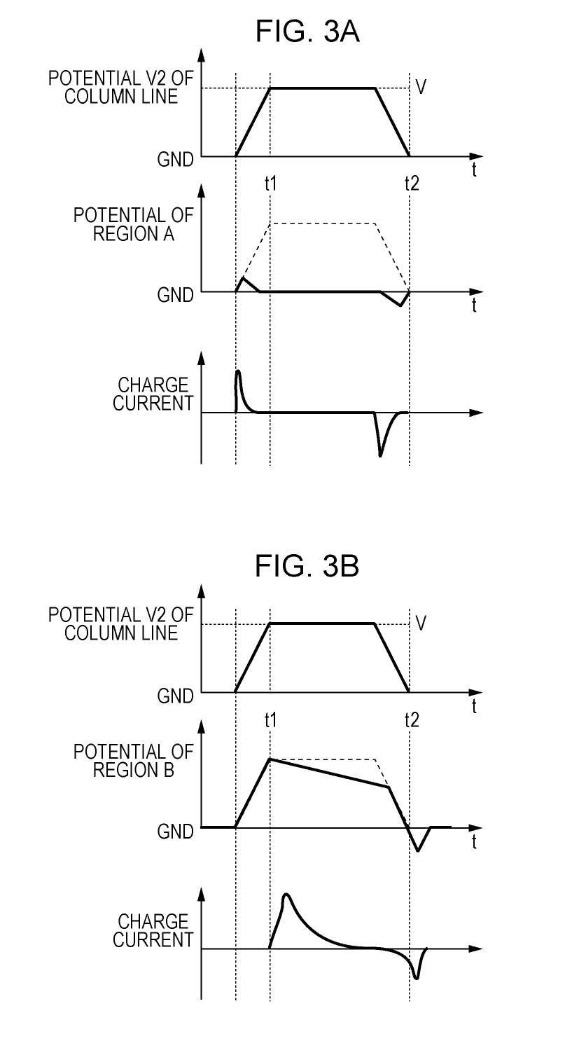

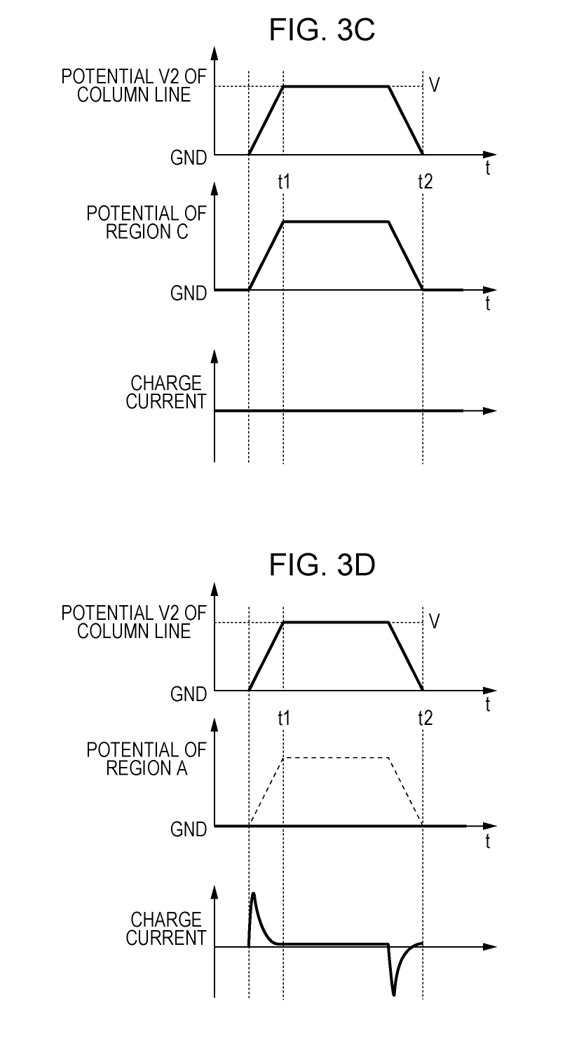

FIG. 2B, as well as FIG. 2A, is an illustration of a rear plate including a resistive film 8 disposed on an insulating layer 3 covering column lines 2. A configuration shown in FIG. 2B is different from that shown in FIG. 2A in that portions of this resistive film 8 that are located near portions 13 of this resistive film 8 that are connected to row lines 4, particularly portions (hereinafter referred to as Regions A) of this resistive film 8 that are spaced from the portions 13 of this resistive film 8 that are connected to these row lines 4 at a distance of less than 5T, overlap with these column lines 2. FIGS. 3A to 3C are schematic graphs illustrating the changes in potential with time of Regions A to C of this resistive film 8 in the case where potentials V2 are applied to these column lines 2 for a predetermined time t. Regions A are those (regions less than 5T) which are adjacent to the portions 13 of this resistive film 8 that are connected to these row lines 4 and in which the distance L from each of the portions 13 of this resistive film 8 that are connected to these row lines 4 does not satisfy Inequality 1. Regions B are those which are adjacent to Regions A and which are spaced from the portions 13 of this resistive film 8 that are connected to these row lines 4 at a distance of 5T or more. Regions C are those which are more spaced from the portions 13 of this resistive film 8 that are connected to these row lines 4 than Regions B. FIG. 3D is a graph illustrating the change in potential with time of a conductor which covers an insulating layer 3 instead of the resistive film 8 shown in FIG. 2B. The potentials of all regions of the conductor behave equally. In each figure, the potential of one of these column lines 2 is shown in an upper area, the potential of this resistive film 8 or the conductor is shown in a middle area, and the charge current flowing through this resistive film 8 or the conductor is shown in a lower area. For ease in description, the supply potential V1 of each row line 4 is set to a GND potential.

With reference to FIG. 3D, the potential of the conductor does not vary but is maintained at the GND potential, which is equal to the row line potential V1, when potentials V2 are applied to these column lines 2. This is because even if the supply of potentials V2 to these column lines 2 causes dielectric polarization in this insulating layer 3, charge currents corresponding to the number of electrons according to the dielectric polarization are quickly supplied through these row lines 4 as shown in the lower area of FIG. 3D since the conductor has extremely low resistance and functions as an electrode. Therefore, the potential of the conductor does not vary but is maintained at the GND potential.

With reference to FIGS. 3A to 3C, the potential of every region of this resistive film 8 varies so as to follow the potential V2 of these column lines 2 because of the influence of the dielectric polarization in this insulating layer 3. The potential of Regions A follows the change of the potential of these column lines 2 to slightly vary for a slight time, particularly a time insufficient to allow the potential of these column lines 2 to reach the maximum potential V2max (a time of less than t1). However, the potential of Regions A stabilizes at the GND potential in a time t1 because Regions A are close to the portions 13 of this resistive film 8 that are connected to these row lines 4 and are quickly supplied with electrons as shown in the lower area of FIG. 3A. The potential of Regions B follows the change of the potential of these column lines 2 to increase to the maximum potential V2max, decreases toward the GND potential because electrons supplied from these row lines 4 reach Regions B as shown in the lower area of FIG. 3B, falls similarly to the potential V2 in accordance with the end of the supply of the potential V2 to these column lines 2, and then reaches the GND potential. The potential of Regions C follows the change of the potential of these column lines 2 to increase to the maximum potential V2max, stabilizes at the same potential as that of these column lines 2, varies in accordance with the decrease of the potential V2 to these column lines 2, and then reaches the GND potential. That is, the change of the potential of Regions C is the same as the change of the potential V2 of these column lines 2. This is because electrons supplied from these row lines 4 do not reach Regions C in the time (time t2) taken to supply the potential V2 to these column lines 2. Therefore, there are no differences in potential between Regions C of this resistive film 8 and these column lines 2 within the time t2 taken to supply the potential V2 to these column lines 2 or no charge currents flow therebetween; hence, no electric power is consumed. This resistive film 8, which is a resistor overlapping with these column lines 2 with this insulating layer 3 disposed therebetween, exhibits a potential behavior different from that of the conductor and does not usually consume electric power as much as the area where this resistive film 8 overlaps with these column lines 2 depending on the time taken to supply potentials these column lines 2. An intensive study has proved that this resistive film 8, which exhibits such a potential behavior different from that of the conductor, has a surface resistivity of 10⁸ Ω/square or more.

There is a region where electric power is consumed because a charge current flows through this resistive film 8 before the time t1 at which the potential of these column lines 2 reaches the maximum potential V2max as shown in FIG. 3A. This is power consumption that is caused before the potential (voltage) needed to emit electrons is applied between a cathode 10 and gate 11 that are a pair of electrodes, that is, power consumption that cannot be avoided by adjusting the time taken to supply potentials to these column lines 2. This embodiment provides a structure in which the surface of the insulating layer 3 is prevented from being charged and the power consumption due to the capacitance between the resistive film 8 and the column lines 2 can be reduced in such a manner that portions of the resistive film 8 that cover the insulating layer 3 as shown in FIG. 2A are limited to Regions B and C, which satisfy Inequality 1, that is, the resistive film 8 and the column lines 2 do not overlap with each other in Regions A. The length of Regions A is described below.

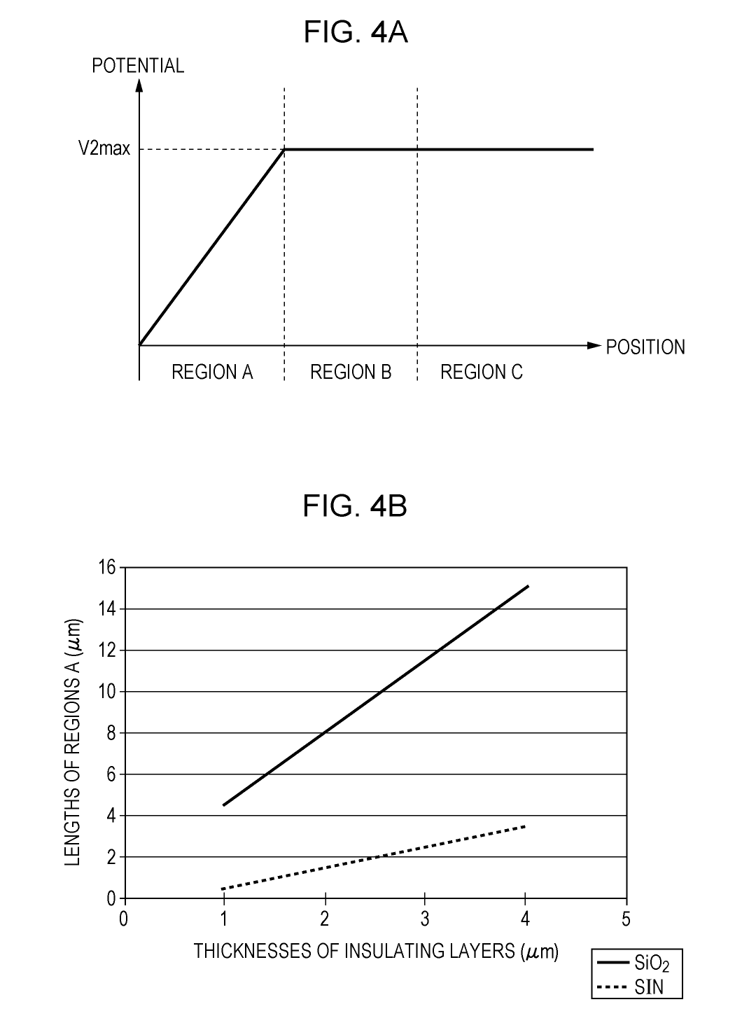

FIG. 4A shows the potential distribution of the resistive film 8 of the configuration shown in FIG. 2B at the point of time (t1 described above) when the potential V2 supplied to each column line 2 reaches the maximum potential V2max. The ordinate of FIG. 4A represents the potential of the resistive film 8 and the abscissa thereof represents the distance from one of the portions 13 of the resistive film 8 that are connected to the row lines 4. As described above, the potential of the resistive film 8 varies from the GND potential to the potential V2 of the column line 2 as shown in FIG. 4A because the potential of the resistive film 8 is affected by the dielectric polarization in the insulating layer 3 due to the supply of a potential to the column line 2. With reference to FIG. 4A, the potential of Regions A, which are located near the portions 13 of the resistive film 8 that are connected to the row lines 4, starts to return to the GND potential at the point of time t1 when the potential V2 of the column line 2 reaches the maximum potential V2max. This is because electrons supplied from the row lines 4 have already reached Regions A as described above. The higher the speed of supplying electrons from the row lines 4 is or the less the supply charge needed (consumed) to return the resistive film 8 to the GND potential is, the larger the length of Regions A is. In particular, our studies have revealed that the length of Regions A is inversely proportional to the surface resistivity of the resistive film 8 and the dielectric constant of the insulating layer 3 and is proportional to the thickness of the insulating layer 3. These correlations can be understood from the fact that Regions A are those where electrons supplied from the row lines 4 have already reached and the electron mobility of the resistive film 8 concerns the speed of supplying these electrons and is inversely proportional to the product of the resistivity and the electron density. These correlations can be also understood from the fact that the supply charge needed (consumed) to return the resistive film 8 to the GND potential is equal to the magnitude of the dielectric polarization in the insulating layer 3 and the magnitude thereof is proportional to the dielectric constant of the insulating layer 3 and is inversely proportional to the thickness thereof. In order to allow the potential of the resistive film 8 to follow the potential of the column lines 2, the resistive film 8 needs to have a surface resistivity of 10⁸ Ω/square or more as described above; hence, the length of Regions A is maximum when the surface resistivity of the resistive film 8 is 10⁸ Ω/square. In order to prevent charge currents from flowing through the column lines 2, the insulating layer 3 needs to have sufficient insulating properties as described above. Our studies have revealed that the insulating layer 3 meets such a requirement and has a dielectric constant of 4.6 or more. Therefore, the length of Regions A is maximum when the dielectric constant of the insulating layer 3 is 4.6.

FIG. 4B shows the relationship between the lengths of Regions A of resistive films 8 having a surface resistivity of 10⁸ Ω/square and the thicknesses of insulating layers 3 which have a dielectric constant of 4.6 and are made of SiO₂ or which have a dielectric constant of 9.0 and are made of SiN. With reference to FIG. 4B, Regions A of the resistive films 8 used in combination with the insulating layers 3 having a dielectric constant of 4.6 have larger lengths as compared to those used in combination with the insulating layers 3 having a dielectric constant of 9.0. This coincides with the results of the above studies. When the dielectric constant is 4.6, the lengths of Regions A are about five times the thicknesses of the insulating layers 3. Therefore, power consumption can be reduced when Regions A have lengths that are five times the thicknesses of the insulating layers 3.

Members used in this embodiment will now be described. Members of the rear plate 30 are described below. The back substrate 1 has strength sufficient to mechanically support the electron-emitting devices 5, the row lines 4, the column lines 2, and so on and is resistant to alkalis and acids used for dry or wet etching or used as developing solutions. Therefore, the back substrate 1 may be made of quartz glass, glass containing a reduced amount of an impurity such as Na, a ceramic material such as aluminum, or the like or may be a sheet of blue glass, a laminate formed by depositing SiO₂ on a sheet of blue glass and a Si substrate by a sputtering process or a similar process, or the like. In this embodiment, the back substrate 1 is made of high-strain point glass such as PD200.

The cathodes 10 and the gates 11 are made of a material having good electrical conductivity, high heat conductivity, and a high melting point. Usable examples of the material include metals such as Be, Mg, Ti, Zr, Hf, V, Nb, Ta, Mo, W, Al, Cu, Ni, Cr, Au, Pt, and Pd; alloy materials containing such metals; carbides such as TiC, ZrC, HfC, TaC, SiC, and WC; borides such as HfB₂, ZrB₂, CeB₆, YB₄, and GdB₄; nitrides such as TaN, TiN, ZrN, and HfN; semiconductors such as Si and Ge; organic polymeric materials; amorphous carbon; graphite; diamond-like carbon; diamond-dispersed carbon; and carbon compounds. A common vacuum deposition process such as a vapor deposition process or a sputtering process can be used to form the cathodes 10 and the gates 11.

The electron-emitting portions 12 may be made of a material which has good electrical conductivity and which can field-emit of electrons. This material has a high melting point of 2,000° C. or higher and a work function of 5 eV or less and is one that is unlikely to form a chemical reaction layer such as an oxide. Usable examples of this material include metals such as Hf, V, Nb, Ta, Mo, W, Au, Pt, and Pd; alloy materials containing such metals; carbides such as TiC, ZrC, HfC, TaC, SiC, and WC; borides such as HfB₂, ZrB₂, CeB₆, YB₄, and GdB₄; nitrides such as TiN, ZrN, HfN, and TaN; amorphous carbon; graphite; diamond-like carbon; diamond-dispersed carbon; and carbon compounds. A common vacuum deposition process such as a vapor deposition process or a sputtering process can be used to form the electron-emitting portions 12.

The row lines 4 and the column lines 2 are not particularly limited and may be made of an electrically conductive material. A printing process or a dispenser coating process can be used to form the row lines 4 and the column lines 2. The column lines 2 may be smaller in width or thickness than the row lines 4 or may be made of a material with an electrical conductivity less than that of a material used to form the row lines 4 so as to have a resistance greater than that of the row lines 4.

The insulating layer 3 is made of a material resistant to high electric fields. Usable examples of this material include oxides such as SiO₂ and nitrides such as Si₃N₄. The insulating layer 3 can be formed by a common vacuum deposition process such as a sputtering process, a chemical vapor deposition (CVD) process, or a vacuum vapor deposition process.

The resistive film 8 is not particularly limited and may be made of a material capable of setting the surface resistivity thereof to 10⁸ Ω/square or more. This material has low electron mobility. Examples of this material include semiconductor materials such as amorphous silicon and carbon.

Members of the face plate 46 are described below.

The front substrate 43 may be made of a material, such as glass, transmitting visible light. In this embodiment, the front substrate 43 is made of high-strain point glass such as PD200.

The light-emitting members 44 may be made of a crystalline phosphor that emits light when being excited by an electron beam. Examples of the phosphor include phosphor materials, cited in, for example, Phosphor Research Society, Phosphor Handbook, Ohmsha, Ltd., for use in conventional CRTs and the like.

The anode 45 may be a metal back, made of Al or the like, known in the field of CRTs. A vapor deposition process using a mask, an etching process, or another process can be used to pattern the anode 45. The thickness of the anode 45 is appropriately determined in consideration of the energy loss of electrons, a preset acceleration voltage (anode voltage), and the reflection efficiency of light because electrons need to pass through the anode 45 to reach the light-emitting members 44.

In this embodiment, light-shielding members 48 are each arranged between the adjacent light-emitting members 44 as shown in FIG. 1.

The light-shielding members 48 may form a black-matrix structure known in the field of CRTs and the like and are usually made of a black metal, a black metal oxide, carbon, or the like. Examples of the black metal oxide include ruthenium oxide, chromium oxide, iron oxide, nickel oxide, molybdenum oxide, cobalt oxide, and copper oxide.

The face plate 46 is bonded to the periphery of the rear plate 30 with the frame 42 placed therebetween, whereby the image display apparatus 47 is formed.

In the case of displaying an image on the image display apparatus 47, driving voltages are applied to the electron-emitting devices 5 in such a manner that a potential Va higher than the potential of the electron-emitting devices 5 is supplied through a high-voltage terminal HV and different potentials are supplied to the row lines 4 and the column lines 2 through terminals Dx and Dy, whereby electrons are emitted from any of the electron-emitting devices 5. The electrons emitted from any of the electron-emitting devices 5 are accelerated and then collide with the light-emitting members 44. This selectively excites the light-emitting members 44 and therefore the excited light-emitting members 44 emit light, whereby an image is displayed.

### EXAMPLE

An example of the present invention will now be described. In this example, an image display apparatus was prepared using a rear plate 30 including electron-emitting devices as shown in FIG. 2A. A face plate used and the configuration of the image display apparatus are as described in the above embodiment and therefore features of this example are described below. In this example, the electron-emitting devices were of a so-called vertical type because of excellent electron-emitting properties. The electron-emitting devices were prepared in such a manner that an insulating member was deposited on a back substrate 1, electron-emitting portions were formed on side surfaces of the insulating member, and gates were formed on the upper surface of the insulating member. The present invention is not limited to a vertical type of electron-emitting device.

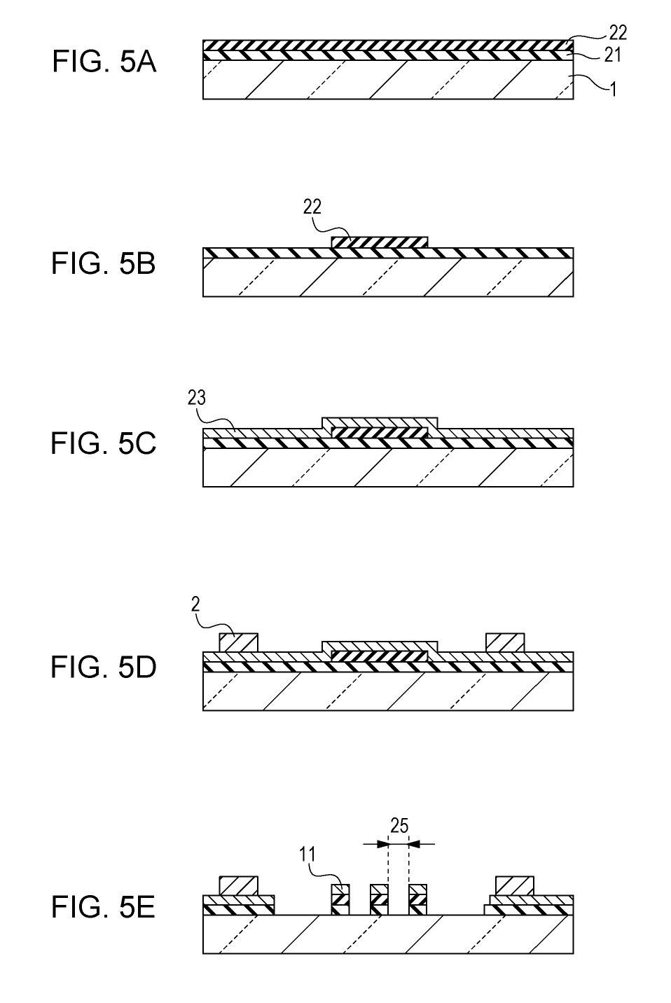

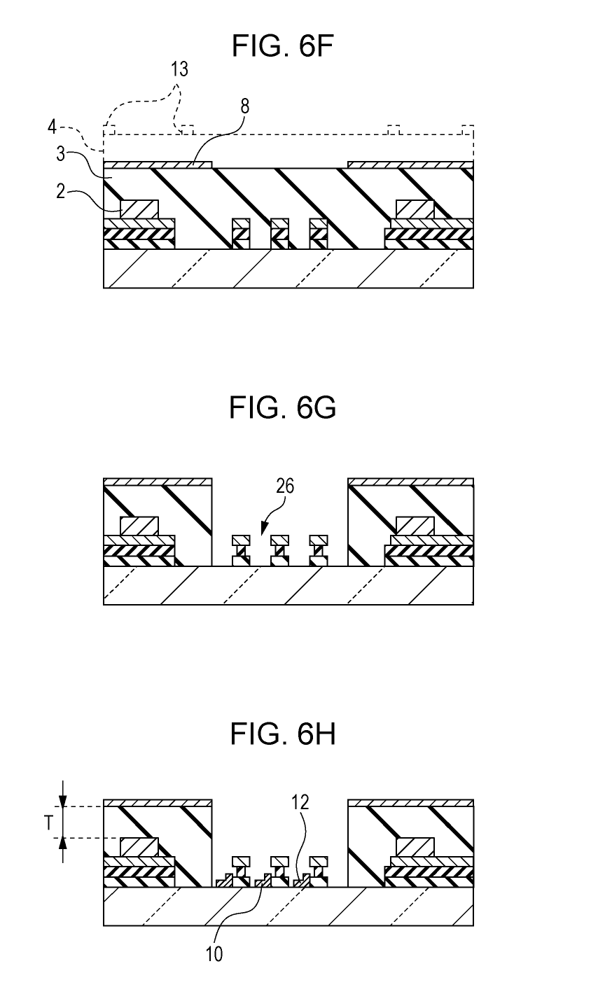

FIGS. 5A to 5E and FIG. 6F to 6H are illustrations showing steps of preparing the rear plate 30. The steps are described below in turn. FIGS. 5A to 5E and FIG. 6F to 6H correspond to a sectional view taken along the line X-X′ of FIG. 2A.

### Step 1

The back substrate 1 prepared was a sheet of blue glass. After the back substrate 1 was sufficiently cleaned, an insulating layer 21 with a thickness of 300 nm was formed in such a manner that Si₃N₄ was deposited on the back substrate 1 by a sputtering process. An insulating layer 22 with a thickness of 20 nm was formed in such a manner that SiO₂ was deposited on the insulating layer 21 by a sputtering process as shown in FIG. 5A.

### Step 2

The insulating layer 22 was coated with a positive photoresist by a spin coating process. The photoresist was exposed to light and was then developed, whereby a resist pattern was formed. The insulating layer 22 was patterned using the patterned photoresist as a mask as shown in FIG. 5B.

### Step 3

A conductive layer 23 with a thickness of 30 nm was formed in such a manner that TaN was deposited on the insulating layer 22 by a sputtering process as shown in FIG. 5C.

### Step 4

A Cu layer with a thickness of 3 μm was deposited on the conductive layer 23 by a sputtering process. The Cu layer was coated with a positive photoresist by a spin coating process. This photoresist was exposed to light and was then developed, whereby a resist pattern was formed. The Cu layer was patterned with an etching solution using this patterned photoresist as a mask, whereby column lines 2 with a width of 20 μm were formed as shown in FIG. 5D.

### Step 5

The conductive layer 23 and the column lines 2 were coated with a positive photoresist by a spin coating process. This photoresist was exposed to light and was then developed, whereby a resist pattern was formed. The insulating layer 21, the insulating layer 22, and the conductive layer 23 were patterned with a CF₄ gas by a dry etching process using this patterned photoresist as a mask, whereby openings 25 were formed and gates 11 made of TaN were formed on insulating members as shown in FIG. 5E.

### Step 6

A SiO₂ layer with a thickness of 3 μm was deposited over the back substrate 1 by a CVD process.

A Cu layer with a thickness of 10 μm was deposited on this SiO₂ layer by an electroplating process. A positive photoresist was provided on this Cu layer by a spin coating process, was exposed to light, and was then developed, whereby a resist pattern was formed. This Cu layer was patterned with an etching solution using this patterned photoresist as a mask, whereby row lines 4 with a width of 250 μm were formed.

A negative photoresist was provided over the row lines 4 by a spin coating process, was exposed to light, and was then developed, whereby a resist pattern was formed.

An amorphous silicon layer with a thickness of 100 nm was deposited over this resist pattern. This resist pattern was stripped off, whereby a resistive film 8, made of amorphous silicon, for preventing static charge was formed. Portions of the resistive film 8 were deposited on the row lines 4 so as not to overlap with the column lines 2, whereby portions 13 of the resistive film 8 that were connected to the row lines 4 were formed as shown in FIG. 6F. In this figure, the row lines 4 and the portions 13 of the resistive film 8, which is located thereon, are illustrated by broken lines.

### Step 7

Regions of the SiO₂ layer formed in Step 6 were patterned by selective etching, the regions being surrounded by the adjacent row lines 4 and the adjusted column lines 2, whereby an insulating layer 3 made of SiO₂ was formed. An etching solution used was buffered hydrofluoric acid (BHF), LAL100, available from Stella Chemifa Corporation. The etching time was 11 minutes. In this step, side surfaces of the insulating members that faced the openings 25 were etched by about 60 nm, whereby notched portions 26 were formed as shown in FIG. 6G.

### Step 8

Mo was deposited on side surfaces of insulating members at an angle of 45 degrees by an oblique deposition process, whereby Mo layers with a thickness of 30 nm were formed. A positive photoresist was provided over the Mo layers by a spin coating process, was exposed to light, and was then developed, whereby a resist pattern was formed. The Mo layers were dry-etched with a CF₄ gas using this patterned photoresist as a mask, whereby cathodes 10 were formed as shown in FIG. 6H.

### Preparation of Image Display Apparatus

The image display apparatus was prepared by the method described in the above embodiment using the rear plate 30, which was prepared as described above, as shown in FIG. 1. The distance L from each of the portions 13 of the resistive film 8 that were connected to the row lines 4 to a corresponding one of portions of the resistive film 8 that overlapped with the column lines 2 was 18 μm (which is six times the thickness T of the insulating layer 3 because the thickness T is 3 μm). The sheet resistance of the resistive film 8 was 1×10¹² Ω/square.

### COMPARATIVE EXAMPLE

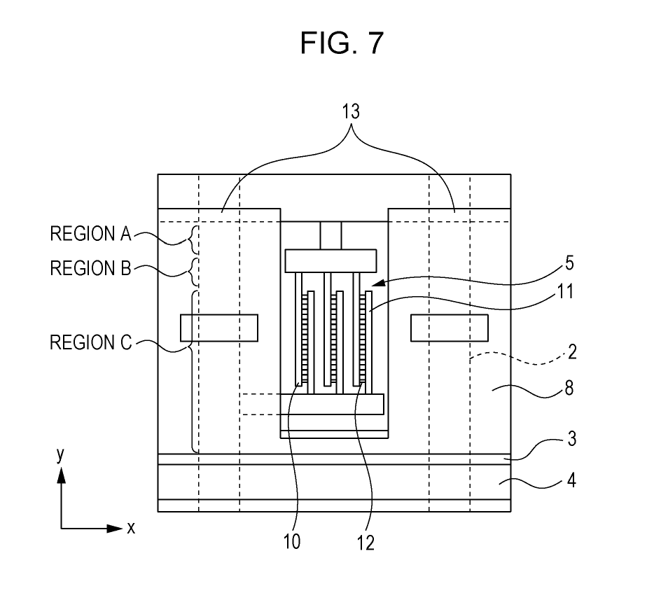

In a comparative example, an image display apparatus including electron-emitting devices structured as shown in FIG. 7 was prepared. In the electron-emitting devices, portions of a resistive film 8 that were connected to row lines 4 were directly above column lines 2 and the distance L from each of the portions of the resistive film 8 that were connected to the row lines 4 to a corresponding one of portions of the resistive film 8 that overlapped with the column lines 2 was substantially zero. In Regions C, openings were provided in portions of the resistive film 8 such that the area where the resistive film 8 overlapped with the column lines 2 was equal to that described in the example. The configuration of the image display apparatus and a method for manufacturing the image display apparatus are the same as those described in the example except those described above and will not be described.

### Evaluation Results

In each image display apparatus prepared as described above, voltages were applied between the cathodes 10 and the gates 11 through lines. In particular, the voltages applied to the column lines 2 were pulsed voltages of +10 V and the voltages applied to the row lines 4 were pulsed voltages of −10 V. A direct-current high voltage of 10 kV was applied to the anode 45 of the face plate 46. The image display apparatus of the example was operated under these conditions. The capacitance of one of the electron-emitting devices included in the image display apparatus of the example was determined to be 0.38 pF. The image display apparatus of the example displayed a distortion-free image. This verified that the image display apparatus of the example had a sufficient antistatic function.

The image display apparatus of the comparative example was operated under the same conditions as those for operating the image display apparatus of the example. The capacitance of one of the electron-emitting devices included in the image display apparatus of the comparative example was determined to be 0.41 pF, which was 8% greater than that of the example. The power consumption of the image display apparatus of the comparative example was about 5% greater than that of the example. It was observed that spots produced by electron beams emitted from the electron-emitting devices of the image display apparatus of the comparative example expanded with operation time. These verified that the image display apparatus of the example had reduced capacitance and reduced power consumption and was capable of displaying a good image.

According to the present invention, an image display apparatus with reduced power consumption can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-289729 filed Dec. 21, 2009, which is hereby incorporated by reference herein in its entirety.

What is claimed is:

1. An image display apparatus comprising:
a rear plate including:
a plurality of electron-emitting devices each including a pair of electrodes and an electron-emitting portion located between the electrodes;
first lines connecting each of the electrodes which is located on one side of a corresponding one of the electron-emitting devices;
second lines which connect each of the electrodes located on the other side of a corresponding one of the electron-emitting devices and which have a resistance greater than that of the first lines;
an insulating layer covering the second lines; and
a resistive film which is connected to the first lines, which has portions overlapping with the second lines, which covers the insulating layer, and which has a surface resistivity of 10⁸ Ω/square or more; and
a face plate including an anode held at a potential higher than that of the electron-emitting devices and light-emitting members that emit light when being irradiated with the electrons emitted from the electron-emitting devices,
wherein the resistive film has portions which do not overlap with the second lines and which are connected to the first lines and the inequality L≧5T is satisfied, where L is a distance between each of the portions of the resistive film that are connected to the first lines and a corresponding one of the portions of the resistive film that overlap with the second lines and T is the thickness of the insulating layer.

2. The image display apparatus according to claim 1, wherein the resistive film is an antistatic film.
